(19) United States
(12) Patent Application Publication
(10) Pub. No.: US 2025/0331094 A1
(43) Pub. Date: Oct. 23, 2025

(54) Magnetic Venturi

(71) Applicant: UNM Rainforest Innovations, Albuquerque, NM (US)

(72) Inventors: Peter V. Vorobieff, Albuquerque, NM (US); Craig Davidson, Albuquerque, NM (US); Adrian Cederberg, Albuquerque, NM (US)

(73) Assignee: UNM Rainforest Innovations, Albuquerque, NM (US)

(21) Appl. No.: 19/186,472

(22) Filed: Apr. 22, 2025

Related U.S. Application Data
(60) Provisional application No. 63/637,224, filed on Apr. 22, 2024.

(51) Int. Cl. H05H 1/40; H05H 1/00

(52) U.S. Cl. CPC H05H 1/40; H05H 1/01

(57) ABSTRACT

A system and method of generating greater ionization using a magnetic venturi.

### RELATED APPLICATIONS

This application claims priority to U.S. Provisional Application No. 63/637,224, filed on Apr. 22, 2024, which is incorporated herein in its entirety.

### STATEMENT REGARDING FEDERALLY SPONSORED RESEARCH & DEVELOPMENT

Not applicable.

### INCORPORATION BY REFERENCE OF MATERIAL SUBMITTED ON A COMPACT DISC

Not applicable.

### FIELD OF THE INVENTION (TECHNICAL FIELD)

The present invention is related to methods and apparatuses for augmenting ionization.

### BACKGROUND OF THE INVENTION

The generation of thrust by the use of magnetic fields has been investigated for over half a century; see for example U.S. Pat. No. 2,997,436: “It has been determined that if a very rapidly changing high-intensity magnetic field is impressed through a working fluid zone that the potentials generated in space cause ionization and produce a plasma. It has also been determined that if the magnetic lines of force define a field of generally conical or tapered configuration, the plasma will be propelled toward the large end of the field. The reason for this is that the plasma is initially pinched at the small end of the tapered magnetic field and as the pinch progresses toward the large end of the field, the plasma is propelled outwardly.”

U.S. Pat. No. 2,442,314 discloses a cascade method of ionization: “[ . . . ] it collides with molecules of the working fluid present and in so doing detaches electrons from atoms of the working fluid molecules, or in other words ionizes the molecules. These detached electrons, in a high field, may, in turn, collide with other working fluid molecules and detach more electrons. The result of this chain-like sequence of events is to produce a large number of electrons which surge to the positively charged wire [ . . . ].”

### BRIEF SUMMARY OF THE INVENTION

While the methods described above require an electric potential to work, an embodiment of the present invention provides a system and method a magnetic venturi achieves the same result without a voltage potential being required, but it requires some seed ionization in the working fluid to start the reaction.

In another embodiment, the present invention provides a system and method of generating greater ionization using a partially ionized working fluid, by ionizing a portion of a first working fluid; the ionized first working fluid ionizing a portion of a second working fluid in a magnetic field; and wherein the magnetic field is produced without requiring external power or electrical potential.

In another embodiment, the present invention provides a system and method wherein the magnetic field is produced by one or more permanent magnets.

In another embodiment, the present invention provides a system and method wherein the magnetic field is produced by one or more electromagnets.

In another embodiment, the present invention provides a system and method wherein the magnetic field is produced by one or more superconductive electromagnetic coils.

In another embodiment, the present invention provides a system and method wherein the magnetic field has a strength of greater than approximately one Tesla.

In another embodiment, the present invention provides a system and method wherein the magnetic field is solenoid shaped.

In another embodiment, the present invention provides a system and method wherein the first working fluid is ionized by an external device, where the external device is selected from the group consisting of plasma torch, ionization pad, laser, solid rocket motor, chemical laser, trigger diodes, or other ionizing devices.

In another embodiment, the present invention provides a system and method of generating greater ionization using a partially ionized working fluid, by ionizing a portion of a first working fluid; the ionized first working fluid ionizing a portion of a second working fluid in a magnetic field; and restricting the flow of the first and second ionized working fluids in a restricting magnetic field; wherein the magnetic field is produced without requiring external power.

It is to be understood that both the foregoing general description and the following detailed description are exemplary and explanatory only and are not restrictive of the invention, as claimed.

### BRIEF DESCRIPTION OF THE DRAWINGS

FIG. 1 shows a magnetic venturi including a funnel portion located inside body for an embodiment of the present invention.

FIG. 2 shows a perspective view of a magnetic venturi for an embodiment of the present invention.

FIG. 3 shows a top view of a magnetic venturi for an embodiment of the present invention.

FIG. 4 shows a side view of a magnetic venturi for an embodiment of the present invention.

FIG. 5 shows a system that includes air input funnel and plasma torch for ionizing a first fluid which exhausts through Lorentz-Townsend cascade into Magnetic Venturi wherein the diameter or size of the flow path is reduced.

FIG. 6A shows the shift to higher ionization levels from the same settings without a Magnetic Venturi.

FIG. 6B shows the shift to higher ionization levels from the same settings with a Magnetic Venturi.

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure, or system. Further, the terms and phrases used herein are not intended to be limiting, but rather to provide an understandable description of the invention.

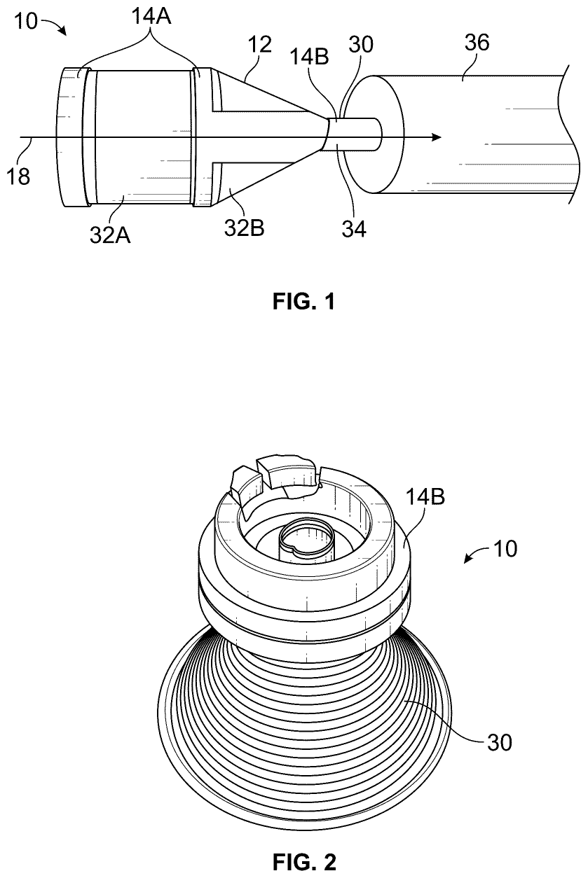

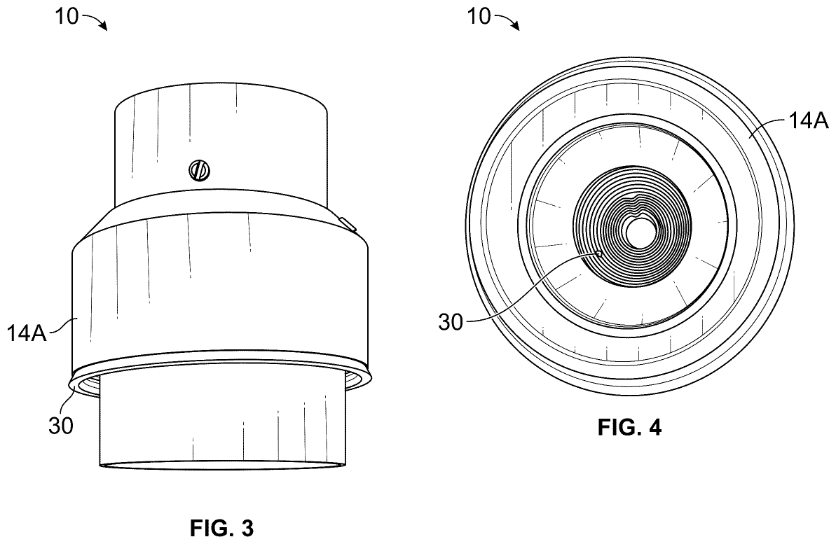

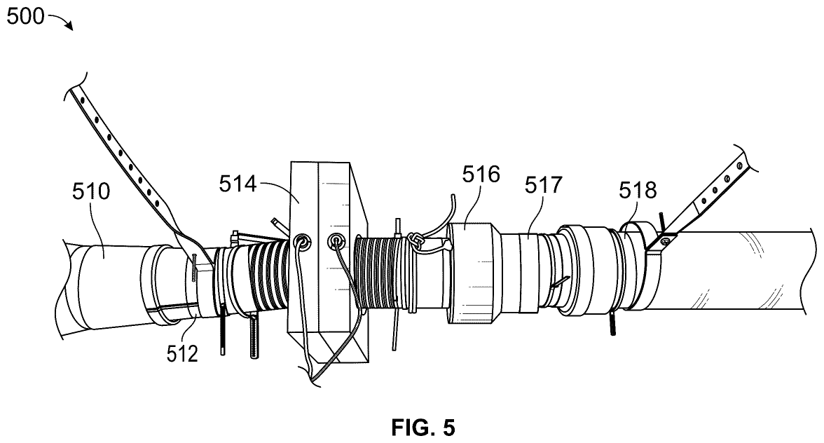

As shown in FIGS. 1-4, an embodiment of the present provides magnetic venturi 10 having a body 12 including one or more magnetics 14. The magnetics may be configured wherein the magnetic field is produced without requiring external power or electrical potential. In yet other embodiments, the magnet field may be produced by permanent magnets, alternatively by electromagnets or superconductive electromagnetic coils.

As further shown in FIG. 1, magnetic venturi includes funnel portion 30 located inside body 12. Body 12 may be configured to provide a first section 32 into a second section 34. The first section has a larger diameter than second section. Configuring body 12 in this manner smoothly funnels a flow 18 through body 12 into funnel neck 30 created by reduced diameter section 34 where the flow is exhausted into a third section 36 having a diameter larger than second section 34.

In use, without electrical charge, flow 18 travels from a less restrictive magnetized volume, as shown by sections 32A and 32B, to a more restrictive magnetized volume (section 34) which inherently increases inelastic particle collisions, increasing the ionization of the working fluid. Accordingly, the embodiments of the present invention include locating one or more magnets in an area of less restrictive volume, a physical enclosure, and one or more magnets 14A, in at least half the form of a traditional physical venturi (section 32A and 32B), and at least one magnet 14B in the more restrictive volume (section 34).

As shown in FIG. 5, other embodiments of present invention include system 500 that includes air input funnel 510 and plasma torch 512 for ionizing a first fluid which exhausts through Lorentz-Townsend cascade 514 into Magnetic Venturi wherein the diameter or size of the flow path is reduced as described above around section 517. Component 518 provides the right half of a traditional physical venturi wherein the area the flow enters is expanded as compared to section 517.

This system enables a method of operation that partially ionizes a working fluid by ionizing a portion of a first working fluid by plasma torch 512. The ionized first working fluid ionizes a portion of a second working fluid in a magnetic field created by magnetic venturi 516 which also restricts the flow of the first and second ionized working fluids in a restricted magnetic field created in section 517. In this embodiment, the magnetic field is produced without requiring external power.

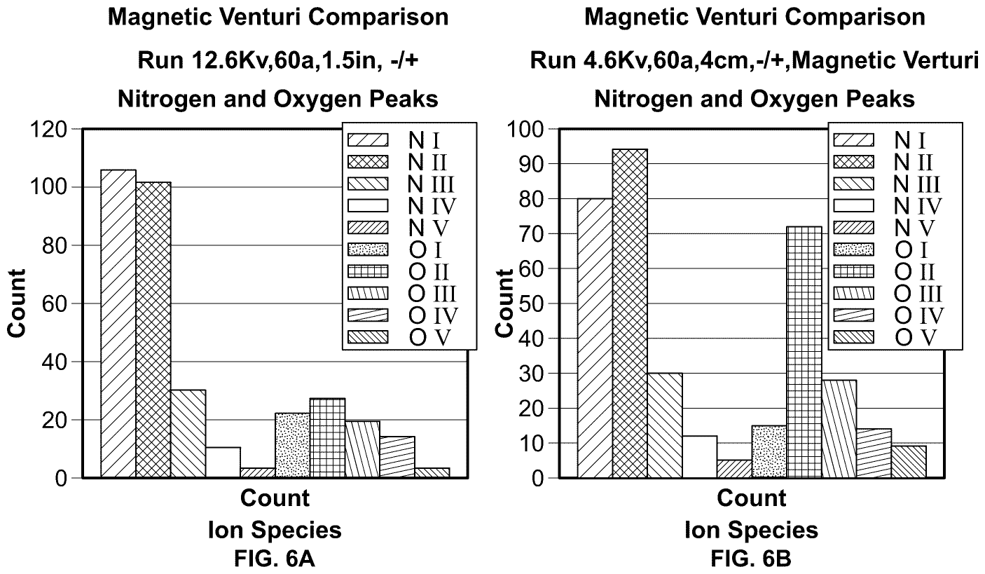

As shown in FIGS. 6A and 6B, the shift to higher ionization levels from the same settings without a Magnetic Venturi (FIG. 6A), and with a Magnetic Venturi (FIG. 6B) are clear. NI is higher in FIG. 6A, NII is higher in FIG. 6A. OII is lower in FIG. 6A, and dramatically higher in FIG. 6B (along with OIII, OIV, and OV). All that was required was a magnet placed in a physical venturi which magnetically connected to the previous described magnets.

In other aspects, the present invention provides methods, systems, and devices for augmenting the ionization of partially ionized working fluids. Working fluids may be composed of plasma mixed with neutral working fluids, liquids, or solids.

The embodiments of the present invention can double the ionization of specific ionic species and increase the overall percentage of ionization of the working fluid. Accordingly, the embodiments of the present invention have applications in propulsion, manufacturing, and 3D printing.

In yet other embodiments, the present invention provides a device, system, and method that generates ionization using a partially ionized working fluid. In this embodiment, a portion of a first working is ionized. Next, a portion of a second working fluid is ionized in the magnetic field wherein the magnetic field is produced without requiring external power or electrical potential.

While the magnetic field may be created in several ways known to those of skill in the art, in a preferred embodiment the magnetic field is produced by permanent magnets, alternatively by electromagnets or superconductive electromagnetic coils. In yet other preferred embodiments, the magnetic field has a strength of greater than approximately one Tesla and maybe solenoid shaped.

In other aspects, the first working fluid is ionized by an external

device. The external device may be a plasma torch, ionization pad, laser, solid rocket motor, chemical laser, trigger diodes, or another ionizing device.

In yet other aspects the present invention provides a system, device, and method to generate ionization using a partially ionized working fluid. Here, a portion of the first working fluid is ionized. The first the ionized first working fluid ionizes a portion of a second working fluid in a magnetic field. Next, the flow of the first and second ionized working fluids is restricted in the magnetic field. Lastly, the magnetic field is produced without requiring external power.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above-described embodiments, methods, and examples, but by all embodiments and methods within the scope and spirit of the disclosure.

What is claimed:

1. A method of generating greater ionization using a partially ionized working fluid, the method comprising:
ionizing a portion of a first working fluid; the ionized first working fluid ionizing a portion of a second working fluid in a magnetic field;
wherein the magnetic field is produced without requiring external power or electrical potential.

2. The method of claim 1 wherein the magnetic field is produced by one or more permanent magnets.

3. The method of claim 1 wherein the magnetic field is produced by one or more electromagnets.

4. The method of claim 1 wherein the magnetic field is produced by one or more superconductive electromagnetic coils.

5. The method of claim 1 wherein the magnetic field has a strength of greater than approximately one Tesla.

6. The method of claim 1 wherein the magnetic field is solenoid shaped.

7. The method of claim 1 wherein the first working fluid is ionized by an external device, where said external device is selected from the group consisting of plasma torch, ionization pad, laser, solid rocket motor, chemical laser, trigger diodes, or other ionizing devices.

8. A method of generating greater ionization using a partially ionized working fluid, the method comprising the steps of:
ionizing a portion of a first working fluid;
the ionized first working fluid ionizing a portion of a second working fluid in a magnetic field; and
restricting the flow of the first and second ionized working fluids in a restricting magnetic field;
wherein the magnetic field is produced without requiring external power.

9. The method of claim 8 wherein the magnetic field is produced by one or more permanent magnets.

10. The method of claim 8 wherein the magnetic field is produced by one or more electromagnets.

11. The method of claim 8 wherein the magnetic field is produced by one or more superconductive electromagnetic coils.

12. The method of claim 8 wherein the magnetic field has a strength of greater than approximately one Tesla.

13. The method of claim 8 wherein the magnetic field is solenoid shaped.

14. The method of claim 8 wherein the first working fluid is ionized by an external device, where said external device is selected from the group consisting of plasma torch, ionization pad, laser, solid rocket motor, chemical laser, trigger diodes, or other ionizing devices.
